(19) United States
(12) Patent Application Publication
(10) Pub. No.: US 2013/0346237 A1
(43) Pub. Date: Dec. 26, 2013

(54) SYSTEMS AND METHODS FOR FACILITATING LOGISTICS TIME SAVINGS

(71) Applicant: William B. Rademaker, Seattle, WA (US)

(72) Inventor: William B. Rademaker, Seattle, WA (US)

(73) Assignee: FLYBUY TECHNOLOGIES, INC., Seattle, WA (US)

(21) Appl. No.: 13/923,079

(22) Filed: Jun. 20, 2013

Related U.S. Application Data
(60) Provisional application No. 61/662,296, filed on Jun. 20, 2012.

(51) Int. Cl. G06Q 10/08; G06Q 30/00

(52) U.S. Cl. CPC G06Q 10/0836; G06Q 30/00
USPC 705/26.8; 705/7.19

(57) ABSTRACT

A logistics management system is provided that alerts a customer regarding nearby purchasing opportunities as the customer travels about accomplishing other scheduled tasks. By gathering information regarding expected locations of the customer at expected times, as well as by tracking customer inventory information along with geographically proximate retailer inventories, the logistics management system may automate orders of products such that the customer may perform curbside pickups of the products as they travel between previously scheduled appointments. The logistics management system may negotiate with retailers for better prices, and/or may cancel other existing orders for products if it is determined that performing a curbside pickup of a product would be preferable. In some embodiments, the logistics management system may manage not only curbside pickups of products, but also access to other resources, such as places in a queue for a resource at a retailer.

### CROSS-REFERENCE TO RELATED APPLICATION

This application claims the benefit of Provisional Application No. 61/662,296, filed Jun. 20, 2012, the entire disclosure of which is hereby incorporated by reference herein for all purposes.

### BACKGROUND

Generally, customers wish to obtain products over the course of a day. Often, customers may have a set of products which they wish to obtain, but have not made specific plans to shop for the products. For example, a customer may know that he needs to buy a light bulb to replace a bulb in his house that has burned out, and so he will stop by a hardware store on the way home from work to purchase the light bulb. Customers may also need items that they are not consciously aware that they need. For example, a home printer may automatically transmit a notification via a communication network or otherwise indicate that ink is running low, and so the printer may indicate that the customer should obtain more ink even if the customer is not consciously aware that this is the case. As another example, home inventory monitoring systems may track grocery items in a pantry or refrigerator, and may note when a particular item is low or runs out.

Though customers are able to stop to obtain products for which they are consciously aware of a need, customers may not always remember to do so, may not always have time to shop for desired products, may not know of nearby retail locations that offer the products for sale, or may not be willing to accept the burden of making time to access a retail location. Further, customers may not always be consciously aware of such needs. What is desired are new methods and systems that help customers efficiently obtain products without negatively impacting other tasks scheduled throughout the day.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of managing curbside pickups of products from retailers is provided. A customer path prediction engine of a logistics management system calculates a predicted path for a customer. A retail negotiation engine of the logistics management system searches retailer inventories associated with retailers near the predicted path for one or more products in a set of product requests associated with the customer. A pickup management system associated with the logistics management system creates one or more curbside pickup orders for products found within the retailer inventories of retailers near the predicted path. A follow-through tracking engine of the logistics management system monitors progress of the customer along the predicted path.

In some embodiments, a computer-implemented method of managing a position of a customer within a queue for a resource at a retailer is provided. A computing device adds an entry associated with the customer to the queue for the resource at a retailer. The computing device monitors a current location and a direction of travel of the customer. The position of the entry in the queue is updated based on the current location and the direction of travel of the customer.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a block diagram that illustrates, at a high level, various aspects of an exemplary embodiment of the present disclosure;

FIG. 2 is a block diagram that illustrates an exemplary embodiment of a logistics management system according to various aspects of the present disclosure;

FIG. 3 is a block diagram that illustrates further details of an exemplary embodiment of a customer computing device, a pickup management system, and a retailer system, according to various aspects of the present disclosure;

FIGS. 4A-4E depict a flow chart that illustrates an exemplary embodiment of a method of managing logistics for curbside pickups according to various aspects of the present disclosure;

FIG. 5 depicts a flow chart that illustrates an exemplary embodiment of a method of managing a position within a queue according to various aspects of the present disclosure; and

FIG. 6 is a block diagram that illustrates aspects of an exemplary computing device appropriate for use with embodiments of the present disclosure.

### DETAILED DESCRIPTION

In some embodiments of the present disclosure, a logistics management system is provided that may have the ability to alert a customer regarding purchasing opportunities over the course of a day as the customer travels about accomplishing other scheduled tasks. By gathering information regarding expected locations of the customer at expected times, as well as by tracking customer inventory information along with geographically proximate retailer inventories, the logistics management system may be configured to automate orders of products such that the customer may perform curbside pickups of the products as they travel between previously scheduled appointments. In some embodiments, the logistics management system may be able to make purchasing decisions for customers in order to ensure that a best possible price is obtained, and/or may be able to cancel other orders for products if it is determined that performing a curbside pickup of a product would be preferable. In some embodiments, the logistics management system may be configurable to manage not only curbside pickups of products, but also access to other resources, such as places in a queue for a resource at a retailer (including, but not limited to, waiting lists for tables at restaurants).

The term “retailer” is used throughout the present disclosure for ease of discussion to refer to an entity that provides a curbside delivery. In some embodiments, a retailer may be a brick-and-mortar store that sells physical products to customers, such as a department store, a grocery store, a hardware store, a bookstore, a restaurant that offers takeout, and/or the like. However, the concept of a “retailer” is not limited to these examples. In some embodiments, a retailer may provide a service that may be coordinated to include a curbside pickup, such as a drycleaner (articles may be dropped off or picked up via a curbside pickup), a licensing facility (forms to be completed may be brought to a curbside pickup instead of requiring the customer to enter the facility and wait in line), and/or the like. Hence, the “product” may be an item being newly purchased by the customer, an item previously owned by the customer that is to be dropped off or picked up at the retailer, a service to be provided to the customer, and/or the like. Other types of businesses may also be considered within the scope of the term “retailer” without departing from the scope of the present disclosure.

The term “employee” is used throughout the present disclosure for ease of discussion to refer to a person associated with a retailer that interacts with an embodiment of a pickup management system, prepares products for delivery to a customer at a pickup location, and/or provides the product to the customer at the pickup location. Typically, this person may be an employee of the retailer, but other people, such as owners of the retailer, temporary staff of the retailer, subcontractors associated with the retailer, volunteers, and/or any other type of person may perform the tasks of the “employee” discussed herein. In some embodiments, some tasks described as performed by an employee may instead be performed by one or more automated systems or devices. In some embodiments, some of the tasks of the employee discussed herein may be performed by third parties. For example, a set of pickup location couriers may be associated with the system 100, and instead of having an actual employee of the retailer take the product to the pickup location, one of the pickup location couriers may be dispatched to the retailer to take the product to the pickup location. In such an embodiment, the actual retailer may have very little interaction with the system 100, to the point where the courier may even enter the retailer and place the order as a regular customer might do instead of having the order transmitted directly by the pickup management system 104 to the retailer. In some embodiments, the customer may be able to designate a third-party to pick up an item for them, and the functionality related to picking up the order may utilize a computing device associated with the third party and designated by the customer.

The terms “curbside delivery” and “curbside pickup” are also used within the present disclosure for ease of discussion to refer to pickups facilitated by embodiments of the pickup management system 301 and the logistics management system 104. These terms are used because in some embodiments a customer may park their vehicle at a pickup location on a street within close proximity to the retailer, a location referred to as “curbside.” While this term is descriptive of some embodiments of the present disclosure, it is not meant to be limiting, and will be understood by one of ordinary skill in the art to include arrival at any type of pickup location via any method of travel. In some embodiments, the pickup location may be mobile (such as a truck, a courier, and/or the like), and the changing location of the pickup location may be tracked via GPS and/or the like in order to provide updated directions to the pickup location for the customer.

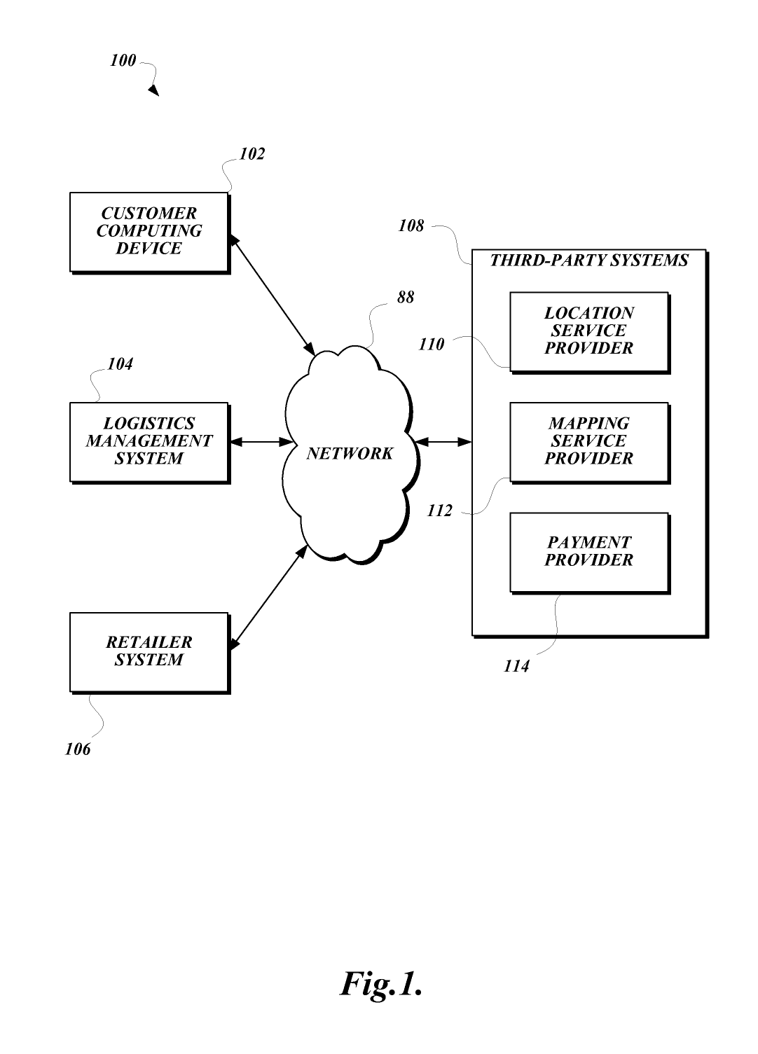

FIG. 1 is a block diagram that illustrates, at a high level, various aspects of an exemplary embodiment of the present disclosure. The illustrated embodiment of the system 100 includes a customer computing device 102, a logistics management system 104, and a retailer system 106. Each of these elements may communicate with each other via any suitable network 88. In some embodiments, the network 88 may include portions of the Internet; cellular telephone data networks such as 3G networks, 4G networks, or LTE networks; wireless networks such as WiFi or WiMax networks; and/or the like.

The customer computing device 102 may be used by the customer to interact with the logistics management system 104, such as for performing actions relating to ordering products, providing payment for products, tracking a location of the customer, guiding the customer to a pickup location, adapting to the actual travel path of the customer, tracking customer inventories, and/or the like. The customer computing device 102 may be configured to allow anonymous communication with a selected retailer, mediated by the logistics management system 104, either by voice, SMS, email, push alerts, and/or any other suitable form of communication.

In some embodiments, the customer computing device 102 may be a mobile device such as a smart phone or tablet computer. In some embodiments, the customer computing device 102 may be any other type of suitable computing device configured to perform the actions described in relation to the customer computing device 102, such as an embedded computing device associated with a vehicle, a desktop computer, a laptop computer, and/or the like. Though the customer computing device 102 is primarily illustrated and described herein as a single computing device, in some embodiments, the functionality of the customer computing device 102 may be split between multiple computing devices. For example, in some embodiments, multiple computing devices may be used by a customer during the course of a single order. In such embodiments, the customer may, for example, place an order or manage inventories with a desktop computer that executes portions of the customer interface engine 302, and may then use a mobile device such as a smart phone and/or the like to execute other portions of the customer interface engine 302 and the location engine 304 to further coordinate pickup of the order while en route to the pickup location. As another example, in some embodiments, some functionality of the customer computing device 102 may be included in one or more separate devices configured to track customer inventories.

The logistics management system 104 may include one or more computing devices such as desktop computers, laptop computers, server computers, and/or the like. In some embodiments, the logistics management system 104 determines products desired by a customer, predicts future locations of the customer, generates curbside pickup orders for products obtainable near the predicted future locations of the customer, and guides the customer to the associated curbside pickup locations. The logistics management system 104 may also be configured to help process payment information received from the customer, and to mediate communication between the customer computing device 102 and a retailer.

The retailer system 106 may include one or more computing devices such as desktop computers, laptop computers, server computers, and/or the like. In some embodiments, the retailer system 106 receives orders from the logistics management system 104 and presents them in a preparation queue on a computing device located at the retailer, so that each order may be prepared by the retailer in time to be delivered to the appropriate customer when the customer arrives at a pickup location. The retailer system 106 may also provide an interface that directs employees of the retailer to the pickup location, and/or allows employees of the retailer to communicate with the customer while the customer is en route to the pickup location. In some embodiments, the retailer system 106 may include one or more mobile employee computing devices, such as smart phones, tablet computers, PDAs, and/or the like, which may execute portions of the retailer interface engine 322 to help an employee manage communications with customers, consummate pickup meetings, and/or any other function of the retailer interface engine 322. In some embodiments, the retailer system 106 may operate separately from any other retailer data management systems, and so no integration between the retailer system 106 and existing point-of-sale devices and/or the like need be performed. For example, components of the retailer system 106 may execute on or be accessible by the mobile employee computing devices only.

As illustrated, the system 100 may also include various third-party systems 108. The customer computing device 102, the logistics management system 104, and the retailer system 106 may be configured to communicate with the third party systems 108 to provide various functionalities. For example, a location service provider 110 such as a Global Positioning System (GPS) service, a cellular positioning system, and/or the like may provide location information identifying a location of the customer. As another example, a mapping service provider 112 such as Google Maps, Bing Maps, Navteq, and/or the like, may provide map images, route-finding functionality, traffic congestion information, and/or the like to other portions of the system 100. As yet another example, a payment provider 114 such as PayPal, a traditional credit card provider, a traditional bank, and/or the like, may be used to provide funds from an account of the customer as a payment for the customer's order from the system 100. The illustrated third-party systems 108 are exemplary only, and in some embodiments, more or fewer third-party systems 108 may also be used. In some embodiments, the system 100 may make use of a third-party product or inventory search engine such as Google Product search and/or the like to find online orders, retailers, or local inventories. In some embodiments, at least some of the functionality provided by the third-party systems 108 may not be provided by third parties, but instead may be provided by the same provider as the pickup management system 104.

Though only a single customer computing device 102, a single retailer system 106, and single copies of third-party systems 108 are illustrated in FIG. 1 for clarity, one of ordinary skill in the art will recognize that, in embodiments of the present disclosure, a logistics management system 104 may be configured to communicate with more than one customer via more than one customer computing device 102, with retailer systems 106 associated with more than one retailer, and more than one location service provider 116, mapping service provider 112, and/or payment provider 114.

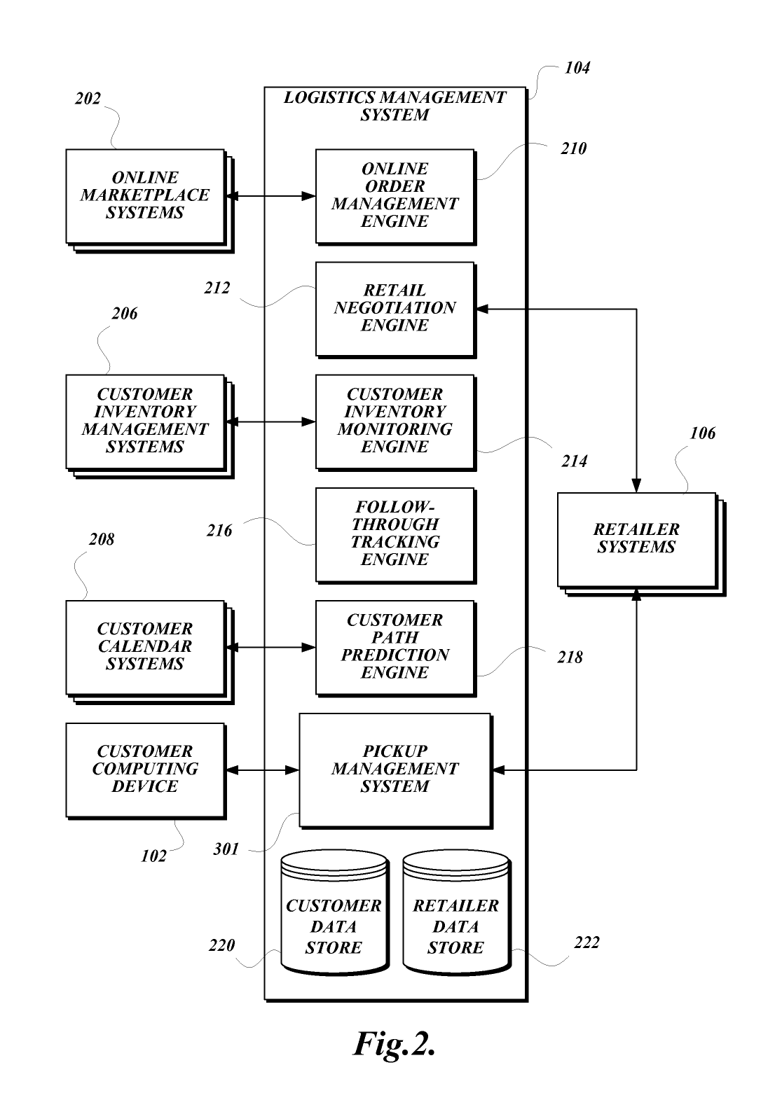

FIG. 2 is a block diagram that illustrates an exemplary embodiment of a logistics management system 104 according to various aspects of the present disclosure. As illustrated, the logistics management system 104 includes an online order management engine 210, a retail negotiation engine 212, a customer inventory monitoring engine 214, a follow-through tracking engine 216, a customer path prediction engine 218, and a pickup management system 301. In general, the word “engine” (used interchangeably with the word “application”), as used herein, refers to logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. An engine may be compiled into executable programs or written in interpreted programming languages. Software engines or applications may be callable from other engines or from themselves. Generally, the engines or applications described herein refer to logical modules that can be merged with other engines or applications, or can be divided into sub-engines. The engines or applications can be stored in any type of computer readable medium or computer storage device and be stored on and executed by one or more general purpose computers, thus creating a special purpose computer configured to provide the engine or application.

The components of the logistics management system 104 work together to create product requests representing products the customer desires, find retailers that can provide those products along a predicted path of travel of the customer, and help guide the customer to curbside pickup locations near their predicted path of travel where the desired products are made available without materially impacting other scheduled appointments the customer plans to attend. In some embodiments, the customer path prediction engine 218 determines a set of locations where the customer is expected to be located at given times. For example, the customer path prediction engine 218 may query one or more customer calendar systems 208 to find appointments scheduled for the customer, or may retrieve standard commuting path information from a customer data store 220, and may determine a predicted path for the customer based on at least this information.

In some embodiments, the customer inventory monitoring engine 214 helps determine when particular products are desired by the customer. For example, the customer inventory monitoring engine 214 may query various customer inventory management systems 206 to determine when inventory of particular products fall below a predetermined level, and may create product requests upon detecting such a fall in quantity. In some embodiments, the customer inventory monitoring engine 214 may receive commands input by the customer in real-time to create product requests.

In some embodiments, the retail negotiation engine 212 may compare an offer for curbside pickup from a retailer to an online offer for sale of the same product, and may only create a curbside pickup order if the offer is better than an online offer. In some embodiments, the retail negotiation engine 212 may transmit messages to attempt to obtain a better offer from the retailer in order to make the offer preferable to the online offer, or preferable to offers available from other retailers. In some embodiments, the online order management engine 210 helps coordinate between online orders and curbside pickup orders for the same product. For example, pending online orders may be replaced by curbside pickup orders if the curbside pickup orders could be obtained faster, could be obtained for less money, or are otherwise preferable to the online order. The online order management engine 210 may cancel the online order for a product upon detecting that the product has already been obtained via a curbside pickup, and may cancel a curbside pickup order or product request upon determining that an online order can no longer be canceled.

Once curbside pickup orders have been created, the follow-through tracking engine 216 monitors the progress of the customer along the predicted path of travel using, for example, a location service provider 110 and/or a location engine 304 of a customer computing device 102 associated with the customer. If the follow-through tracking engine 216 determines that a curbside pickup order is not likely to be completed as originally scheduled while remaining on time for any scheduled appointments, it may reschedule the curbside pickup order to a point later on the predicted path (or near the predicted path) when the order could be completed, may reschedule the curbside pickup order at the same location but at a later time, or may cancel the order.

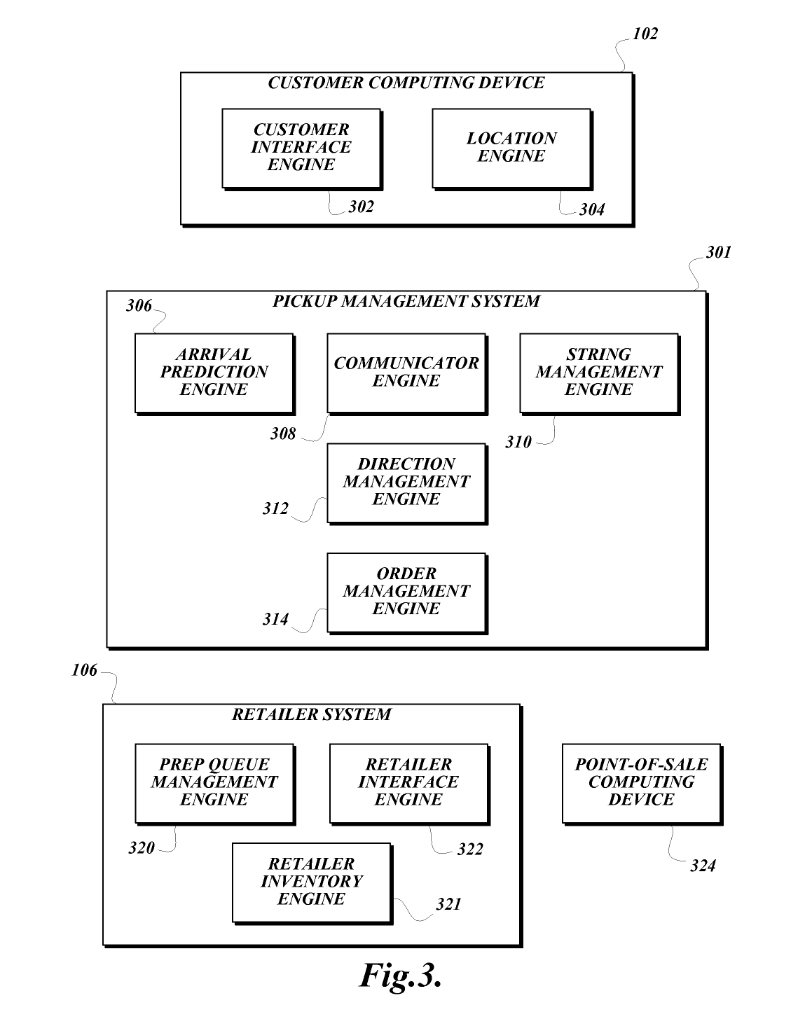

The pickup management system 301 handles coordination between the retailer and the customer in processing curbside pickups scheduled by other components of the logistics management system 104, and is described further below in the discussion of FIG. 3.

As illustrated, the logistics management system 104 also includes a retailer data store 222 and a customer data store 220. As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed packet switched network. However, any other suitable storage technique and/or device capable of quickly and reliably providing the stored data in response to queries may be used, and the computing device may be accessible locally instead of over a network, or may be accessible over some other type of suitable network or provided as a cloud-based service. A data store may also include data stored in an organized manner on a storage medium 908, as described further below. One of ordinary skill in the art will recognize that separate data stores described herein may be combined into a single data store, and/or a single data store described herein may be separated into multiple data stores, without departing from the scope of the present disclosure.

In some embodiments, the retailer data store 222 may be configured to store information associated with a plurality of retailers. For example, the retailer data store 222 may store information associated with each retailer that uses the system 100 including, but not limited to, a location of the retailer, a set of predetermined pickup locations associated with the retailer, contact information for the retailer, a set of products made available by the retailer for pickup, financial account information for the retailer into which payments received from customers are to be submitted, time periods during which the retailer does or does not provide pickup services through the system 100, a maximum rate of orders that the retailer is willing or able to fulfill, and/or the like. In some embodiments, the retailer data store 222 may not be configured to store a set of products made available by the retailer for pickup. Instead, the logistics management system 104 may obtain that information directly from a retailer inventory engine 321 of the retailer (described further below), or from a third-party aggregator of product and/or inventory information, such as Google Product Search and/or the like. In some embodiments, the retailer data store 222 may describe how to access one or more retailer systems 106 associated with retailers, and/or may store information retrieved from a retailer systems 106 for redundancy or ease of access.

The stored information regarding the set of predetermined pickup locations may include indications of time periods during which the predetermined pickup locations are available. As a nonlimiting example, the stored information may indicate that a parking spot is available as a pickup location all day except for during an afternoon commuting period, during which time the parking spot is a tow away zone. For some retailers, less than all of the information for which the retailer data store 222 is configured to store may be stored in the retailer data store 222. In some embodiments, the retailer data store 222 may provide products for presentation to the customer and subsequent selection, while in other embodiments, the retailer data store 222 may provide a link to a service operated by the retailer from which the customer may select products for pickup and/or from which products may be automatically ordered by the logistics management system 104.

In some embodiments, the customer data store 220 may be configured to store information associated with a plurality of customers. For example, the customer data store 220 may store information associated with each customer that uses the system 100 including, but not limited to, login information, contact information for the customer, payment account information for the customer, a description of a vehicle associated with the customer, favorite orders previously placed by the customer, and/or the like. The customer data store 220 may also include information about past orders placed by the customer, current orders being processed for the customer, and/or the like.

In some embodiments, the customer data store 220 may be configured to store historical location information for the customer, to provide further data for the logistics management system 104 to use in predicting future locations for the customer. As one nonlimiting example, the customer data store 220 may include information describing a typical route the customer takes while commuting, as well as typical times at which the customer travels the typical route. As another example, the pickup management system 301 may have access to schedule data for the customer, such that the pickup management system 301 may be able to predict the travel of the customer based on appointments within the customer's schedule.

In some embodiments, the customer data store 220 may be configured to store historical order information for the customer, such that the logistics management system 104 may determine commonly ordered products for the customer and suggest creating product requests for such products at appropriate times. As one nonlimiting example, the logistics management system 104 may detect that a customer is browsing a web site and/or other retailer purchasing interface, and may determine based on data stored in the customer data store 220 that the customer tends to order a given product from the retailer after browsing the web site. In such a case, the logistics management system 104 may automatically create a product request for the given product after the customer browsed the web site, whether an online order was created or not.

FIG. 3 is a block diagram that illustrates further details of an exemplary embodiment of a customer computing device 102, a pickup management system 301, and a retailer system 106, according to various aspects of the present disclosure.

As illustrated, the customer computing device 102 includes a customer interface engine 302 and a location engine 304. In the illustrated embodiment, the customer interface engine 302 may be a program executing on the customer computing device 102, an HTML5 application or other web application presented by the customer computing device 102, or any other suitable type of user interface. In some embodiments, the customer interface engine 302 may include a web browser plug-in, add-on, or other technology that is configured to monitor web browsing, and may cause an interface element to be displayed that leads the customer to create a product request in the logistics management system 104.

The customer interface engine 302 provides an interface to various functionalities provided by the logistics management system 104. For example, the interface provided by the customer interface engine 302 may allow the customer to change customer profile information that includes customer name information, billing information, visual identification information, and/or the like; specify customer inventories to track, including connection information to allow the logistics management system 104 to directly access data from a customer inventory management system 206; specify customer calendars to trace, including connection information to allow the logistics management system 104 to directly access data from a customer calendar system 208; set default travel options such as standard commuting paths and times and/or default transportation methods; and/or the like. As another example, the customer interface engine 302 may be configured to help a customer create a product request by presenting a list of available products, accepting an order for a product, requesting a return, canceling an order, accepting payment for the order, and/or the like. As yet another example, the customer interface engine 302 may display prompts to help guide the customer to one or more curbside pickup locations, and/or may provide a communication interface to allow the customer to communicate with a retailer associated with a particular order.

The location engine 304 tracks the location of the customer and reports the location to the logistics management system 104. In some embodiments, the location engine 304 may obtain the customer's location from a location service provider 110, or may derive the customer's location based on information received from a location service provider 110. In some embodiments, the location engine 304 may independently determine the location of the customer using any suitable technique, such as dead reckoning, triangulation, manual input, and/or the like. The location engine 304 may also report the location of the customer to other components of the system 100, such as directly to the customer interface engine 302 or to the retailer system 106. In some embodiments, the location engine 304 may report the location of the customer computing device 102 to the logistics management system 104 at times when orders are not currently pending. The logistics management system 104 may determine a predicted path for the customer based on the reported location, along with other information accessible by the logistics management system 104.

As illustrated, the pickup management system 301 includes an arrival prediction engine 306, a communicator engine 308, a string management engine 310, a direction management engine 312, and an order management engine 314. The arrival prediction engine 306 is configured to receive location information from the location engine 304. The arrival prediction engine 306 may then use the location information to predict a time of arrival for the customer at one or more pickup locations. The arrival prediction engine 306 may use a path generated by the direction management engine 312, generated by the mapping service provider 112, specified by the customer, generated by the customer path prediction engine 218, or from some other source along with the current location of the customer to determine the predicted arrival time. Other sources of information, such as traffic information, weather information, an average speed of travel of the customer or the customer's vehicle, and/or the like, may also be used in generating the predicted arrival time. The arrival prediction engine 306 may be configured to recalculate the predicted arrival time upon receipt of further information, such as a detection of a variance of a location of the customer from the predicted path of travel, detection of a spontaneous and/or unplanned stop, a re-sorting of stop orders, and/or the like. If a substantially different arrival time is predicted, the arrival prediction engine 306 may notify the follow-through tracking engine 216 or other components of the logistics management system 104 so that future scheduled curbside pickup orders may be rescheduled, modified, or canceled as appropriate.

The communicator engine 308 is configured to provide one or more communication channels between customers and retailers to help facilitate pickup of orders. For example, the communicator engine 308 may relay messages between a given customer and a given retailer regarding the exact pickup location, regarding revisions of the predicted arrival time, and/or any other types of messages. In some embodiments, the communicator engine 308 may provide a layer of anonymity to the customer by shielding the contact information of the customer from the retailer, and only allowing the retailer to contact the customer through the communicator engine 308. This may encourage customers to communicate with retailers, as the customers do not risk further unwanted contact from the retailer after the pickup transaction is completed. In some embodiments, the communication channel provided by the communicator engine 308 may remain usable for a limited amount of time after the pickup transaction is completed, which would allow the customer to contact the retailer in order to, for example, address problems with the product discovered after the pickup transaction is completed, and/or the like. In some embodiments, a provider of the logistics management system 104 may be able to intervene in a communication channel between a customer and a retailer, for example to provide customer service and/or to help ensure a successful pickup.

The direction management engine 312 is configured to provide instructions for how to reach curbside pickup locations. In some embodiments, the instructions as determined by the direction management engine 312 are presented to the customer via the customer interface engine 302 on the customer computing device 102. Even in situations where the customer knows how to reach the retailer from the customer's current location, the instructions may be helpful to direct the customer to a particular pickup location associated with the retailer, such as a particular parking space, a particular side of the street, an approach path, and/or the like. The instructions may direct the customer in a most efficient way to the pickup location, may help improve the accuracy of the predicted arrival time by having the customer travel a known route, and/or the like. In some embodiments, the instructions may not direct the customer directly to the pickup location, but may instead direct the customer to a start of an approach path to the pickup location. For example, the instructions may initially direct the customer to a point one block to the east of the pickup location, so that the customer approaches the pickup location from the east. Multiple such locations may be used, so that the retailer can establish an approach path to the pickup location, such as a path around the block, a horse-shoe path, and/or the like, to manage the path of approach of the customers. In some embodiments, the instructions may include a button that allows the customer to indicate that they are starting along the indicated path to the pickup location. If the customer may arrive before the product is ready for pickup (such as, for example, if the customer is ten minutes away from a retailer that offers a product that requires a minimum of fifteen minutes of preparation time), the button may be greyed-out or otherwise disabled until the retailer has enough time to have the product ready by the time the customer is expected to arrive.

In some situations, the pickup location may not be associated with any one particular retailer but instead will be used by multiple retailers at once (as will be discussed further below), and so the instructions will be useful to the customer to find the common pickup location. In some embodiments, the direction management engine 312 may also be configured to provide instructions to the retailer for how to reach pickup locations. For example, the direction management engine 312 may direct an employee of the retailer to a particular parking space, may direct an employee to a pickup location not associated solely with the retailer but instead used by multiple retailers at once, and/or the like.

The order management engine 314 is configured to accept orders associated with customers for products, and to process those orders. In some embodiments, the order management engine 314 may be configured to accept orders created by other components of the logistics management system 104, from third-party ordering systems, by a web site associated with a brick-and-mortar retailer, and/or the like, as well as directly from customers. The string management engine 310 is configured to manage strings of orders, such that multiple products may be picked up from multiple retailers in an efficient manner.

Though some aspects of the pickup management system 301 are discussed above, further details about the capabilities, operation, and deployment of a pickup management system 301 in managing a curbside pickup of an order of a given product by a customer and strings of orders of multiple products from multiple retailers may be found in commonly owned, co-pending PCT Application No. PCT/US2012/030613, filed Mar. 26, 2012, the entire disclosure of which is hereby incorporated by reference for all purposes. The pickup management system 301 is similar to the pickup management system described in this co-pending application, though the illustrations of the customer data store 220 and retailer data store 222 have been moved from the pickup management system to the logistics management system 104. In some embodiments, despite the fact that these data stores have been illustrated as part of the logistics management system 104, any of the components of the pickup management system 301 and the logistics management system 104 may access the content of the data stores. The pickup management system and related methods described in the co-pending application are used to coordinate curbside pickups otherwise planned and monitored by other components of the logistics management system 104 described herein.

As illustrated, the retailer system 106 includes a retailer interface engine 322, a preparation queue management engine 320, and a retailer inventory engine 321. The retailer interface engine 322 allows employees of retailers to interact with various functionality of the pickup management system 301. For example, employees may use the retailer interface engine 322 to communicate with customers via the communicator engine 308. Employees may also use the retailer interface engine 322 to modify information stored within the retailer data store 222, such as predetermined pickup locations associated with the retailer, a rate at which the retailer is willing or able to fulfill orders, and/or the like. As stated above, the retailer system 106 may include one or more mobile employee computing devices configured to execute portions of the retailer interface engine 322 to help an employee manage communications with customers, consummate pickup meetings, and/or any perform other function associated with the retailer interface engine 322. In some embodiments, the retailer inventory engine 321 is configured to store and maintain information regarding products available at the retailer for sale. The information may include any type of information normally stored to track inventory, such as product types, product identifiers (such as SKUs, UPCs, and/or the like), quantities, and/or the like. In some embodiments, the retailer inventory engine 321 may provide an interface accessible via the network 88 for the logistics management system 104 to query for available products. The interface may be accessible programmatically, may be reachable using a URL or other internet address, and may provide secure access using user names, passwords, and/or any other suitable technique.

In some embodiments, the preparation queue management engine 320 is configured to display orders received from customers such that employees of the retailer may ensure that the orders are prepared and brought to the associated pickup location at a time when the customer is expected to arrive. In some embodiments, the preparation queue management engine 320 may be integrated with automated food preparation machines, and may instruct the automated food preparation machines to begin preparation of the food items at an appropriate time. In some embodiments, the preparation queue management engine 320 may be integrated with a variety of in-store timing mechanisms usable to prompt employees to begin preparing orders at appropriate times. The preparation queue management engine 320 may be configured to receive new orders from the pickup management system 301, and to intelligently reorder a queue presented to employees of the retailer to ensure that each of the orders is completed at the appropriate time.

As illustrated, the retailer may also be associated with a point-of-sale computing device 324. The point-of-sale computing device 324 may be configured to accept orders and payments from a traditional customer already located at the retailer. In some embodiments, the point-of-sale computing device 324 is configured to submit such orders to the preparation queue management engine 320 to be included in the preparation queue along with orders received from the pickup management system 301. In such an embodiment, the retailer may be able to process both traditional orders and orders submitted through the pickup management system 301 in an efficient and timely manner. In some embodiments, the point-of-sale computing device 324 may include inventory management functionality configured to manage inventory at the retailer. In such embodiments, the point-of-sale computing device 324 may communicate with the retailer inventory engine 321 to update stored inventory amounts upon consummation of sales of products. The illustrated point-of-sale computing device 324 should not be seen as limiting the types of devices with which the retailer system 106 and/or the logistics management system 104 may integrate. In some embodiments, the retailer system 106 and/or the logistics management system 104 may integrate with automated product preparation devices (such as automated sandwich-making machines in a restaurant and/or the like), existing preparation queue management systems employed for drive-throughs, kitchen display management, and/or the like, and/or any other suitable device or system.

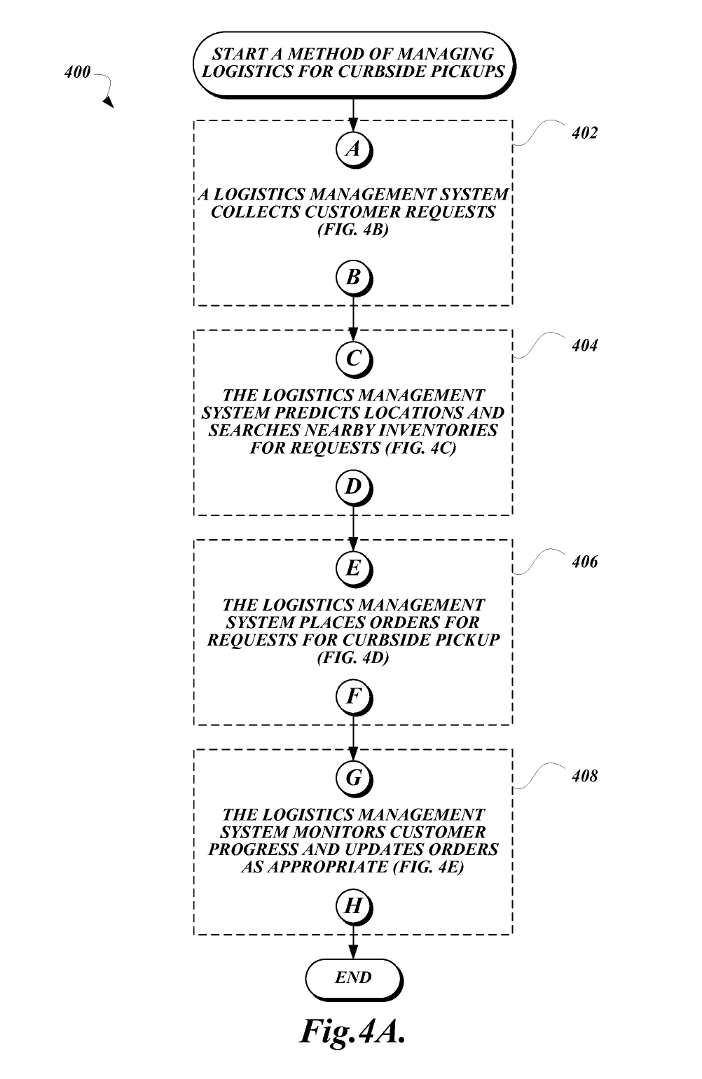

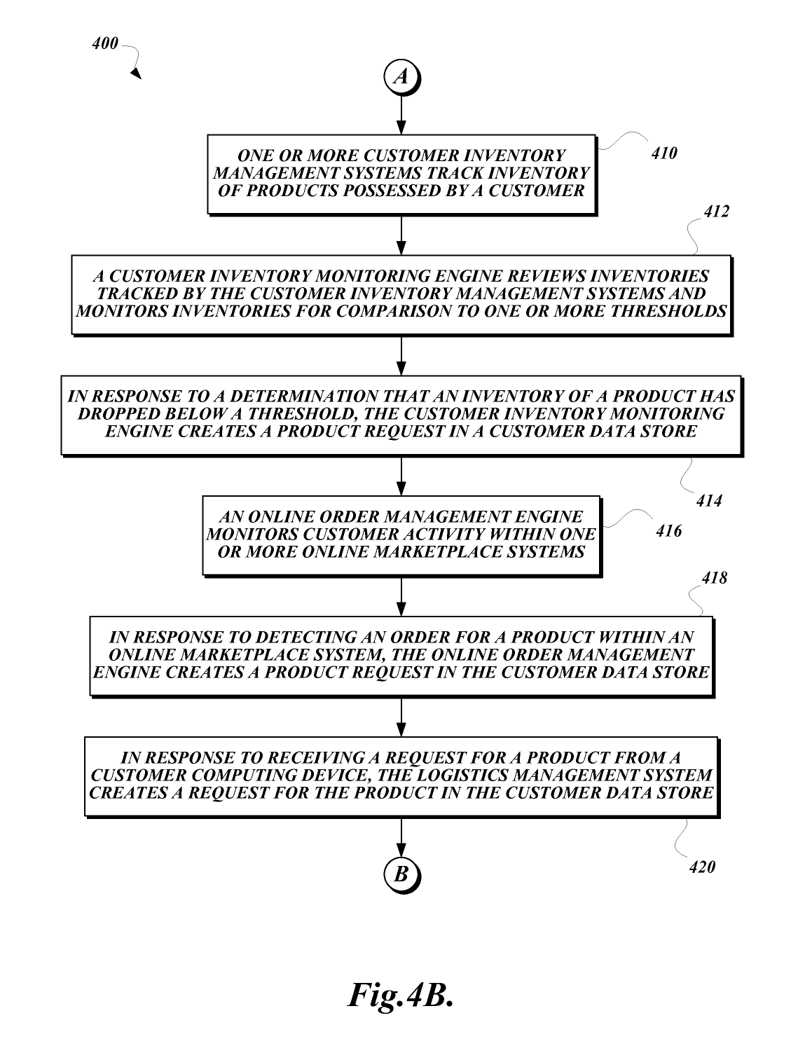

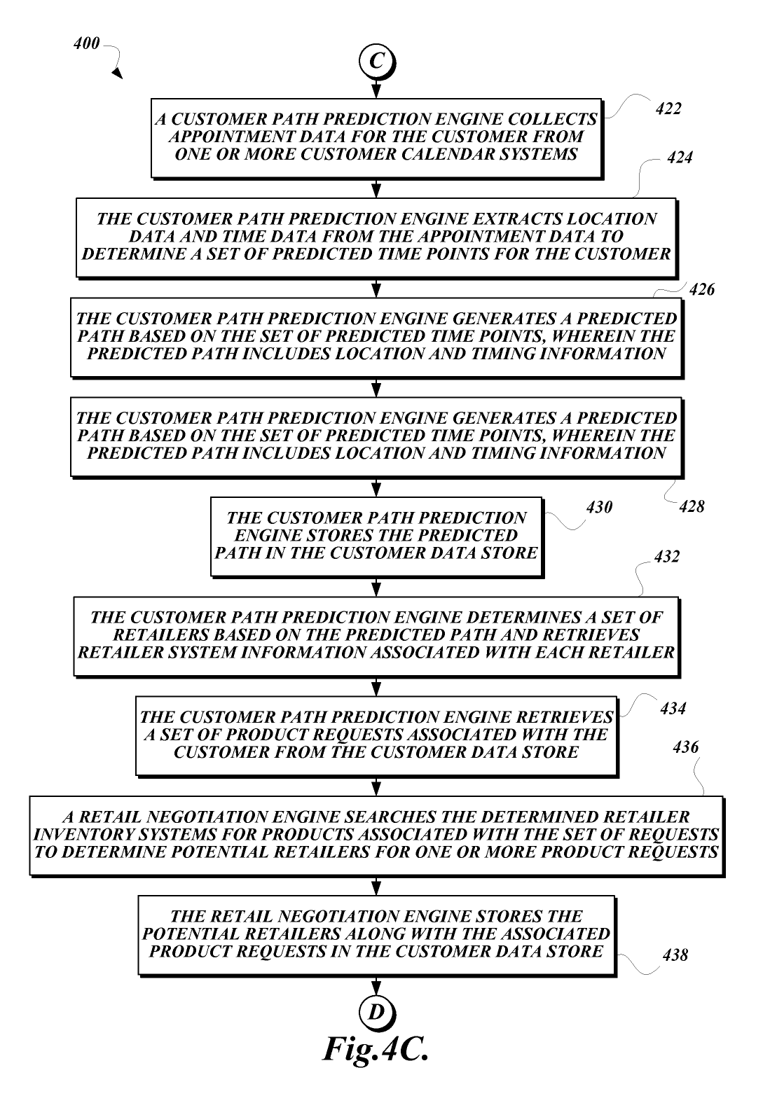

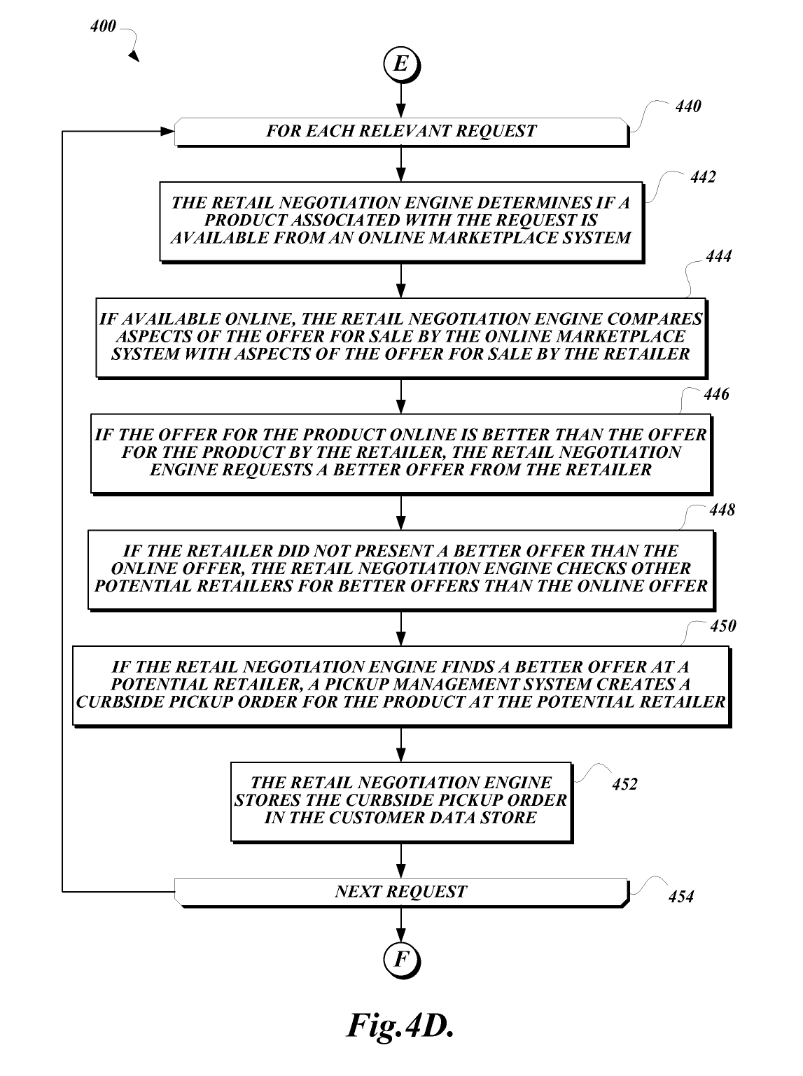

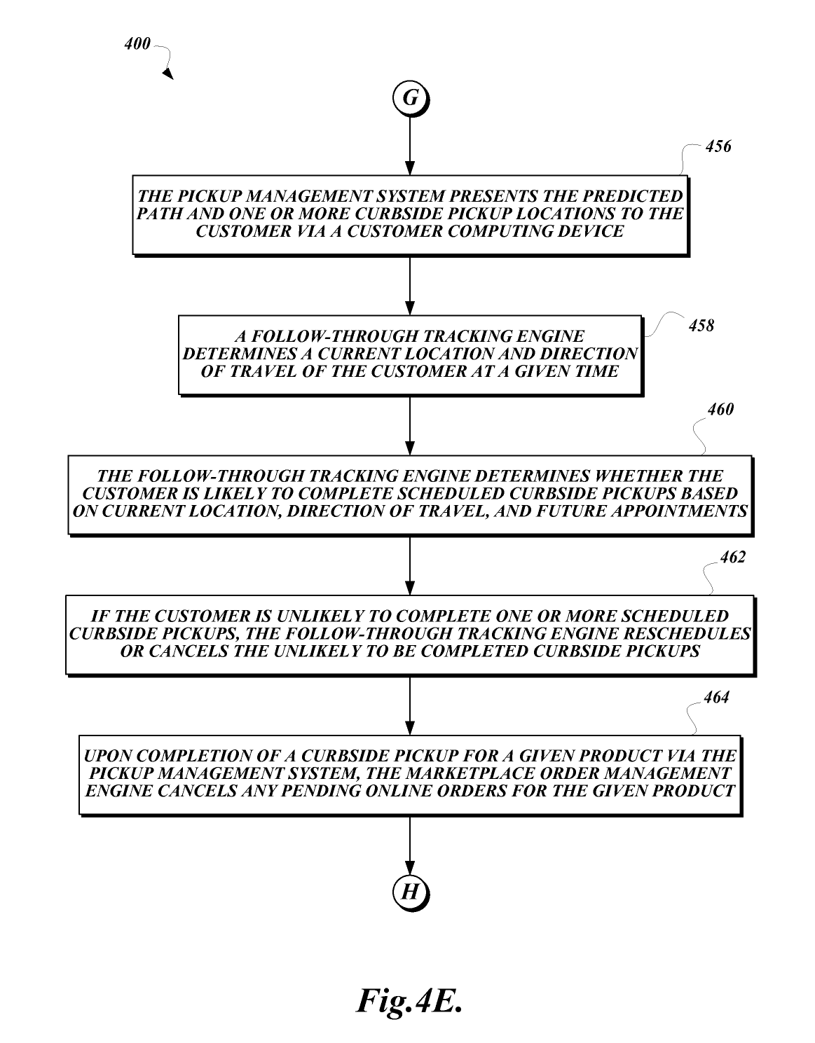

FIGS. 4A-4E depict a flow chart that illustrates an exemplary embodiment of a method 400 of managing logistics for curbside pickups according to various aspects of the present disclosure. Form a start block, the method 400 proceeds to a set of method steps 402 defined between a start terminal (“terminal A”) and an exit terminal (“terminal B”), wherein a logistics management system 104 collects customer requests.

From terminal A (FIG. 3), the method 400 proceeds to block 410, where one or more customer inventory management systems 206 track inventory of products possessed by a customer. In some embodiments, the customer inventory management systems 206 may track physical items in a refrigerator, a pantry, and/or the like, and may keep track of products added or removed using bar codes, RFID tags, image-based product recognition, manual entry, or any other suitable technique. In some embodiments, the customer inventory management systems 206 may track inventory items based on anticipated use without tracking actual use of the items. For example, if a customer adds thirty cans of cat food to an inventory and indicates to the customer inventory management system 206 that one can of cat food is used every day, the customer inventory management system 206 may reduce the inventory amount of cat food by one can a day, such that the customer inventory management system 206 indicates that no cat food is left after thirty days.

At block 412, a customer inventory monitoring engine 214 of the logistics management system 104 reviews inventories tracked by the customer inventory management systems 206 and monitors inventories for comparison to one or more thresholds. In some embodiments, the customer inventory monitoring engine 214 may perform monitoring by transmitting queries to customer inventory management systems 206, and comparing inventory amounts contained in the query responses to threshold amounts stored in the customer data store 220. In some embodiments, the customer inventory management systems 206 may store and monitor threshold amounts of inventory, and may transmit notifications to the customer inventory monitoring engine 214 upon detecting that a monitoring threshold for a product has been crossed.

At block 414, in response to a determination that an inventory of a product has dropped below a threshold, the customer inventory monitoring engine 214 creates a product request in a customer data store 220. The product request includes at least information that identifies the desired product, a desired quantity of the product, and information for associating the product request with the customer (such as a customer ID and/or the like). Information that identifies the desired product may include one or more of a product name, a product model number, a stock-keeping unit (SKU), a Universal Product Code (UPC), an International Article Number (EAN), and/or the like. The product request may also include other information, such as an indication of urgency (e.g., the product may be obtained when convenient, the product should be obtained as soon as possible, the product should be obtained before a specified date, and so on).

In some embodiments, inventory monitoring may not be the only way that product requests for the customer are collected by the logistics management system 104. For example, at block 416, an online order management engine 210 monitors customer activity within one or more online marketplace systems 202. Next, at block 418, in response to detecting an order for a product within an online marketplace system 202, the online order management engine 210 creates a product request in the customer data store 220. The creation of product requests in response to detecting a pending online order for a product allows a curbside pickup of the order to take the place of waiting for delivery of the product from the online marketplace, thus providing the product to the customer more quickly and efficiently. In some embodiments, the product request created at block 418 may include an indication of an online order that matches the product request. In some embodiments, the product request created at block 418 may also include further information about the corresponding online order, such as an expected fulfillment date, a delivery date, or a deadline for canceling the online order. In such embodiments, the product request may be deleted by the logistics management system 104 once the date has been reached, as the product may have already been obtained by the customer, or the customer may no longer be able to replace the online order with the curbside pickup order and would want to avoid ending up obtaining the product via both orders.

In some embodiments, the automatic methods of adding product requests described above may be replaced or supplemented by manual entry of product requests. For example, at block 420, in response to receiving a request for a product from a customer computing device 102, the logistics management system 104 creates a request for the product in the customer data store 220. In some embodiments, manual creation of product requests may occur using the customer interface engine 302 of the customer computing device 102, using techniques similar to those discussed in the commonly-owned, co-pending PCT application incorporated by reference above.

Once product requests are collected, the method 400 proceeds to terminal B. From terminal B (FIG. 4A), the method 400 proceeds to a set of method steps 404 defined between a start terminal (“terminal C”) and an exit terminal (“terminal D”), wherein the logistics management system 104 predicts future locations of the customer, and searches inventories of retailers near the predicted locations for requested products.

From terminal C (FIG. 4C), the method 400 proceeds to block 422, where a customer path prediction engine 218 collects appointment data for the customer from one or more customer calendar systems 208. The customer calendar systems 208 may include one or more calendar system accessible via a network 88 including, but not limited to, Google Calendar, Microsoft Exchange, Windows Live Calendar, a CalDAV server, another calendar server that supports the iCalendar format, or any other system that stores and provides access to appointment data that includes time and location info. Next, at block 424, the customer path prediction engine 218 extracts location data and time data from the appointment data to determine a set of predicted time points for the customer. Each predicted time points includes a predicted location and a predicted time at which the customer will be located in the predicted location. In some embodiments, the predicted time point may include an indication of urgent-ness. For example, some appointments may be tentatively scheduled, and so an associated predicted time point may include an urgent-ness indication that shows that the predicted time point may be moved or skipped altogether. As another example, some appointments may be urgent, and so an associated predicted time point may include an urgent-ness indication that shows that the predicted time point may not be moved, and that curbside pickups that may impact arrival at the predicted time point should be rescheduled. In some embodiments, a predicted time point may include a start time and an end time that correspond to information in the appointment data in order to indicate an amount of time that the customer is expected to spend at the location.

At block 426, the customer path prediction engine 218 generates a predicted path based on the set of predicted time points, wherein the predicted path includes location and timing information. In some embodiments, the customer path prediction engine 218 may determine path information between predicted time points by using a mapping service provider 112. In some embodiments, the customer path prediction engine 218 may obtain path information determined by the direction management engine 312 of the pickup management system 301. In some embodiments, the customer path prediction engine 218 may receive an indication of a predicted path via an input from the customer, such as by the customer dragging their finger along a map displayed by the customer interface engine 302 to indicate the path. Such an embodiment may function to allow the customer to use the logistics management system 104 to interactively search for desired inventory items (or items explicitly specified by the customer) that are available along the indicated path.

In some embodiments, the predicted path may include a small number of predicted time points, such as time points associated with the appointments retrieved from the customer calendar systems 208. In other embodiments, the predicted path may be augmented with additional information, such as an actual route predicted to be taken between predicted time points as obtained from the mapping service provider 112, historical movement data stored in association with the customer in the customer data store 220, and/or other information to help predict the path that will be taken by the customer. In some embodiments, the predicted path may include predicted time points other than the predicted time points associated with the appointments. For example, additional predicted time points may be extrapolated from the predicted time points associated with the appointments, based on the times and locations of the predicted time points associated with the appointments, as well as other factors, including but not limited to traffic information, speed limits, weather information, and/or the like. In some embodiments, the predicted path may be based on expected modes of travel. For example, one path may be predicted if the customer is expected to drive from one predicted time point to the next predicted time point, while a different path may be predicted if the customer is expected to walk from one predicted time point to the next predicted time point. As another example, yet another path may be predicted if the customer is expected to take a train or bus from one predicted time point to the next predicted time point, and this path may include route and/or schedule data from a train schedule or bus schedule to improve the accuracy of the path. As yet another example, a mode of travel may include a car service such as a town car service, a taxi service, and/or the like. In such cases, the predicted path may be based on an amount of time the customer is expected to wait for the car to be dispatched and arrive at the customer's present location. Once the predicted path is generated, at block 430, the customer path prediction engine 218 stores the predicted path in the customer data store 220.

The method 400 then proceeds to block 432, where the customer path prediction engine 218 determines a set of retailers based on the predicted path and retrieves retailer system information associated with each retailer. The retailer system information may include information that enables the logistics management system 104 to interact with the retailer system 106, such as an internet address, a URL, a login and password, and/or the like. The set of retailers may be determined based on retailer locations stored in the retailer data store 422, and may be chosen by comparing the retailer locations to one or more appointment locations, one or more time point locations, and/or the like. In some embodiments, pickup locations associated with the retailers may be used instead of or in addition to the retailer locations. In some embodiments, the retailer may be selected if the associated retailer location or pickup location is on the predicted path, if the associated retailer location or pickup location is within a certain distance of the predicted path, if the predicted path can be altered to go past the retailer location or pickup location without altering the total time or distance of the predicted path any more than a predetermined threshold time or distance, if the predicted path can be altered to go past the retailer location or pickup location without missing a subsequent appointment, and/or using any other suitable criteria.

At block 434, the customer path prediction engine 432 retrieves a set of product requests associated with the customer from the customer data store 220, and at block 436, a retail negotiation engine 212 searches the determined retailer systems 106 for products associated with the set of product requests to determine potential retailers for one or more product requests. For some product requests of the set of product requests, the retail negotiation engine 212 may not be able to find a potential retailer if none of the retailers along the predicted path offer the product. For some product requests of the set of product requests, the retail negotiation engine 212 may find more than one potential retailer that offers the product. In such cases, the retail negotiation engine 212 may select all of the potential retailers, may select one of the potential retailers based on price comparisons or proximity of the retailer to the predicted path, and/or may use any other suitable technique. In the embodiments described above, retailers are first be filtered based on location, and then by product availability. In some embodiments, retailers may first be filtered based on product availability regardless of location, and may then be selected based on location. Next, at block 438, the retail negotiation engine 438 stores the potential retailers along with the associated product requests in the customer data store 220. The method 400 then proceeds to terminal D.

From terminal D (FIG. 4A), the method 400 proceeds to a set of method steps 406 defined between a start terminal (“terminal E”) and an exit terminal (“terminal F”), wherein the logistics management system 104 places orders for requests for curbside pickup. From terminal E (FIG. 4D), the method 400 proceeds to a for loop defined between a for loop start block 440 and a for loop end block 454. The for loop operates over the product requests of the set of product requests for which at least one potential retailer near the predicted path of the customer can provide the product for a curbside pickup.

For a given product request, the method 400 proceeds from the for loop start block 440 to block 442, where the retail negotiation engine 212 determines if a product associated with the product request is available from an online marketplace system 202. In some embodiments, the retail negotiation engine 212 may check the product request in the customer data store 220 to determine whether an online order for the product is pending, as discussed above with respect to block 418. In some embodiments, the retail negotiation engine 212 may work with the online order management engine 210 to query one or more online marketplace systems 202 to find online offers for the product in the absence of an existing order, or to find other online offers in addition to an existing order.

Next, at block 444, if the product is available from an online marketplace system 202, the retail negotiation engine 212 compares aspects of the offer for sale by the online marketplace system 202 with aspects of the offer for sale by the retailer. Aspects of the offers that may be compared may include, but are not limited to: product price; total order cost including tax, shipping, etc.; wait time for delivery; impact on loyalty programs (that is, reward points may be earned for one offer but not for the other offer); and the like. Comparing the aspects may include performing a direct comparison, or comparing a difference between the offers to thresholds defined by the customer. For example, the online offer may be considered better if it offers next day delivery, but immediate curbside pickup may be considered better if delivery of the online offer would occur in more than one day. As another example, the curbside pickup may be considered better unless the price of the online offer is more than 10% less than the curbside pickup price (or any other threshold amount). As yet another example, curbside pickups may be considered better unless the online offer includes free shipping. In some embodiments, each of these thresholds may be strictly adhered to for each aspect compared. In some embodiments, comparisons for several aspects may be weighted and combined for an overall offer comparison score that is compared to a comparison threshold. In some embodiments, combinations of weighted comparisons and strict threshold comparisons may be used.

At block 446, if the offer for the product online is better than the offer for the product by the retailer (based on one or more of the criteria discussed above), the retail negotiation engine 212 requests a better offer from the retailer. In some embodiments, a message requesting a better offer may be transmitted to and displayed by the retailer system 106, which may then provide an opportunity for an employee of the retailer to submit a response via the retailer interface engine 322. In some embodiments, the message may include a proposed offer that is better than the online offer that the employee may accept or deny. In some embodiments, the message as presented via the retailer interface engine 322 may allow the employee to propose their own offer. The better offer provided by the retailer may include a price reduction, a bonus item to be included with the order for no additional charge, a coupon for use in a later purchase at the retailer, a special exclusive status with the retailer, and/or any other suitable improvement to the offer. In some embodiments, the retail negotiation engine 212 may impose a strict time limit for reply to the message to allow planning of the curbside pickups to continue. In some embodiments, the employee of the retailer may be allowed to provide an offer that is better than the original offer from the retailer, but that may not necessarily be better than the online offer.

Once the response to the message requesting the better offer is received, the method 400 proceeds to block 448, where, if the retailer did not present a better offer than the online offer, the retail negotiation engine 212 checks other potential retailers for better offers than the online offer. In some cases, the previous retailer may have been chosen due to proximity to the predicted path, a non-binding customer preference, or some other reason that prioritized the previous retailer over other eligible retailers that provide the product. If so, the retail negotiation engine 212 may choose another of these eligible retailers and compare an offer for sale by this other retailer to the online offer. As discussed above with respect to block 446, if the offer for sale by the other retailer is not better than the online offer, the retail negotiation engine 212 may request a better offer from the other retailer. In some embodiments, offers from retailers may be compared to each other in a similar way, and the retail negotiation engine 212 may compare offers from retailers and request better offers to allow retailers to compete amongst each other for business (as opposed to only allowing retailers to compete for business with online offers). In some embodiments, the best offer amongst the retailers before negotiation may not be negotiable to beat an online offer, though another retailer may provide a better offer after negotiation than the online offer and the previous best offer amongst the retailers.

At block 450, if the retail negotiation engine 212 finds a better offer for the product at a potential retailer (or if no online offer was available), a pickup management system 301 creates a curbside pickup order for the product at the potential retailer, and at block 452, the retail negotiation engine 212 stores the curbside pickup order in the customer data store 220. If no offers were available from retailers that were better than the online offer, the product request may be skipped. This leaves the product request in the customer data store 220 for possible curbside fulfillment in the future. If this is the case, in some embodiments, the online order management engine 210 may create an online order if there was not already an online order for the product and if the retailer offers weren't better than the online offers.

The method 400 then proceeds to the for loop end block 454. If any further unprocessed product requests remain in the set of product requests, the method 400 returns to the for loop start block 440. Otherwise, the method 400 proceeds to terminal F. From terminal F (FIG. 4A), the method 400 proceeds to a set of method steps 408 defined between a start terminal (“terminal G”) and an exit terminal (“terminal H”), wherein the logistics management system 104 monitors customer progress and updates orders as appropriate.

From terminal G (FIG. 4E), the method 400 proceeds to block 456, where the pickup management system 301 presents the predicted path and one or more curbside pickup locations to the customer via a customer computing device 102. The creation of the curbside pickup order and management of the individual curbside pickup order, including managing preparation queues at the retailer, guiding the customer to the curbside pickup location, and so on, are covered in detail co-pending application incorporated by reference above. Such details not repeated here for brevity, but in summary, the pickup management system 301 causes the customer computing device 102 to guide the customer to each curbside pickup location, and the current location of the customer is monitored by the pickup management system 301 such that the retailer can provide the product to the curbside pickup location when the customer arrives. As described in the co-pending application, the curbside pickups may be handled by the pickup management system 301 as individual pickups or as strings.

While the pickup management system 301 handles details of the fulfillment of individual curbside pickups, the other portions of the logistics management system 104 monitor progress of the fulfillment of the product requests along the predicted path as a whole, monitor progress of the customer throughout the course of the predicted path, and rearrange the predicted path and scheduled curbside pickups as appropriate. Accordingly, at block 458, a follow-through tracking engine 216 determines a current location and direction of travel of the customer at a given time. Next, at block 460, the follow-through tracking engine 216 determines whether the customer is likely to complete scheduled curbside pickups based at least on the current location, the direction of travel, and/or one or more future appointments. For example, the follow-through tracking engine 216 may determine, based on traffic, a method of travel, a current speed and location, and/or the like, whether the customer will be able to arrive at next curbside pickup in the predicted path at the predicted time of arrival. As another example, the follow-through tracking engine 216 may determine, based on similar information, whether the customer is actually proceeding on predicted path, or whether they are likely headed somewhere else, such as to their next appointment (instead of the next curbside pickup). As yet another example, and based on similar information, the follow-through tracking engine 216 may determine whether the customer will be able to both arrive to a given curbside pickup, and get to their next appointment on time, or whether the given curbside pickup should be rescheduled in order to ensure that the appointment will be reached on time.

The method 400 then proceeds to block 462, where, if the customer is unlikely to complete one or more scheduled curbside pickups, the follow-through tracking engine 216 reschedules or cancels the unlikely-to-be-completed curbside pickups. If there is room in the predicted path to schedule the curbside pickup later along the predicted path at the same retailer, the follow-through tracking engine 216 may cause the curbside pickup to simply be rescheduled to a new time. If the same product is available later along the predicted path from a different retailer, the follow-through tracking engine 216 may cancel the original curbside pickup in favor of a new curbside pickup of the same product from a different retailer. If no rescheduled or new pickup can replace the original curbside pickup that will be missed, the follow-through tracking engine 216 may simply cause the curbside pickup to be canceled and removed from the predicted path. In some embodiments, rescheduling the curbside pickup may include transmitting a notification by the pickup management system 301 to the retailer system 106 to allow the prep queue management engine 320 to reschedule preparation of the product as appropriate for the newly expected time of arrival. In some embodiments, upon detecting that the customer is unlikely to complete a curbside pickup, the follow-through tracking engine 216 may cause a message to be transmitted to the customer to verify that the pickup will be rescheduled. This message may also allow the customer to override the rescheduling and keep the original curbside pickup, even if the follow-through tracking engine 216 determined that the customer will likely be late for a future appointment. If the customer overrides the rescheduling, the follow-through tracking engine 216 may alter the rest of the predicted path to accommodate the later curbside pickup.

At block 464, upon completion of a curbside pickup for a given product via the pickup management system 301 (that is, the curbside pickup was consummated as detected by the retailer system 106 and the pickup management system 301), the marketplace order management engine 210 cancels any pending online orders for the given product. By waiting until the curbside pickup is completed, cancellation of pending online orders for curbside pickups that may not be completed can be avoided, and so online orders will not be unnecessarily delayed. One of ordinary skill in the art will recognize that any of the actions described with respect to blocks 458-464 may occur repeatedly or continuously while curbside pickups in the predicted path remain uncompleted.

Once all scheduled curbside pickups in the predicted path have been completed or canceled, the method 400 proceeds to terminal H, and from terminal H (FIG. 4A) to an end block, where the method terminates. In some embodiments, the logistics management system 104 may continue to guide the customer to future appointments even if all curbside pickups have been completed.

The discussion above primarily relates to the acquisition of products by the customer. However, in some embodiments of the present disclosure, other types of logistical resources may be managed as well. In some embodiments, the logistics management system 104 may manage access to a resource at a retailer for which customers must often wait after arrival. For example, popular restaurants often have a waiting list for tables, and potential customers join the waiting list after arriving at the restaurant and must thereafter wait for those customers who arrived earlier to be seated first. As another example, activities such as practicing golf at a driving range are first-come, first-serve, and so arriving during a busy time may require a wait after arrival. Using embodiments of the present disclosure, the retailer may allow customers to check in to the queue for the resource (such as a waiting list for tables at a restaurant or a stall at a driving range) before arriving at the retailer, and may monitor the progress of the customer in traveling to the retailer in order to preserve or alter the customer's place in the queue.

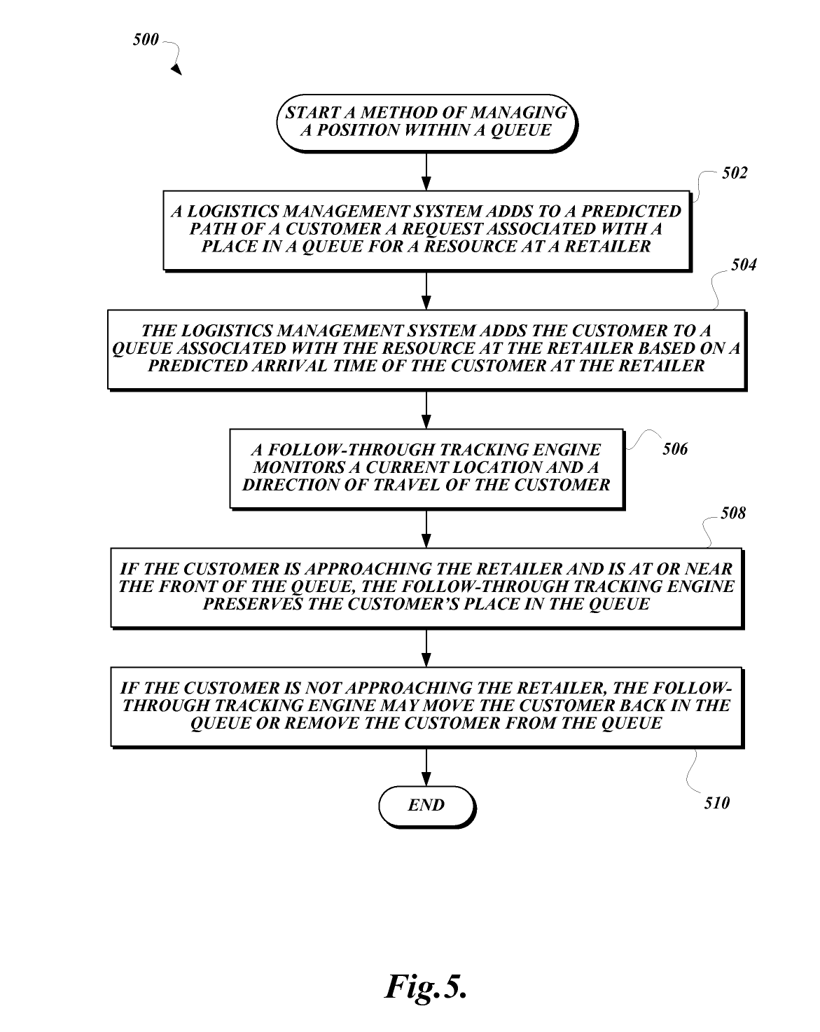

FIG. 5 depicts a flow chart that illustrates an exemplary embodiment of a method 500 of managing a position within a queue according to various aspects of the present disclosure. From a start block, the method 500 proceeds to block 502, where a logistics management system 104 adds to a predicted path of a customer a request associated with a place in a queue for a resource at a retailer. The predicted path may include other curbside pickup orders as discussed above, though in some instances, the predicted path may only include the place request. The predicted path may be derived from other information known about customer's predicted locations as discussed above, may be manually entered by the customer, may be a path determined by the logistics management system 104 or a mapping service provider 112 from the customer's current location to the location of the retailer, or may be derived via any other suitable technique. In some embodiments, the request may include further information about how the customer intends to utilize the resource. For example, if the retailer is a restaurant and the resource to be utilized is a table, the request may specify how many people are in the customer's party, whether the customer is willing to sit in the bar, whether the customer would prefer a booth or a table, whether the customer would like to sit outside or inside, and/or the like. As another example, if the retailer is a bank and the customer desires in-person services, the request may specify what type of transaction will occur (a deposit, a withdrawal, a loan application, and/or the like).

At block 504, the logistics management system 104 adds the customer to a queue associated with the resource at the retailer based on a predicted arrival time of the customer at the retailer. The position at which the customer is added to the queue may be at the end of the queue in order to provide equitable treatment to other customers, including other customers waiting in the queue at the retailer and/or other customers who were previously added to the queue by the logistics management system 104. In some embodiments, the position at which the customer is added to the queue may be determined such that the customer is expected to reach the front of the queue at the time at which the customer is expected to arrive at the retailer. The expected arrival time may be based on the current position of the customer and/or other aspects of the predicted path as discussed above, and may also be based on mode of travel, traffic, expected departure time, and/or the like, as also discussed above. Once an expected arrival time is determined the position in the queue may be determined by comparing the expected arrival time to the expected speed at which customers in the queue will be served. If the predicted arrival time is far in the future, the customer may be left off of the queue until a time when placing the customer at the end of the queue would result in the customer reaching the front of the queue at the expected arrival time.

In some embodiments, some retailers may have more than one queue to manage incompatible resource types. For example, a restaurant may maintain separate queues for 2-top tables, 4-top tables, tables in the bar, outdoor tables, booths, and/or the like. As another example, a bank may maintain separate queues for normal tellers and for loan officers. The logistics management system 104 may choose a queue based on the information about the customer's desires included in the request, and matching the desires to an appropriate queue.

Next, at block 506, a follow-through tracking engine 216 monitors a current location and a direction of travel of the customer. At block 508, if the customer is approaching the retailer and is at or near the front of the queue, the follow-through tracking engine 216 preserves the customer's place in the queue. In other words, if the customer has reached the front of the queue and has not yet arrived at the retailer, the follow-through tracking engine 216 will hold the customer's spot at the front of the queue until the customer gets there, assuming the customer is actually progressing toward the retailer. In some embodiments, detecting travel on the predicted path toward the retailer indicates that the customer is progressing toward the retailer. In some embodiments, other types of travel may also satisfy the condition of approaching the retailer. For example, if the customer has reached a parking lot associated with the retailer (yet is not traveling toward the retailer), it may be assumed by the follow-through tracking engine 216 that the customer is searching for parking and therefore should have the place saved in the queue. In some embodiments, preserving the customer's place in the queue is performed by leaving the customer at the front of the queue and allowing places behind the customer in the queue to be serviced until the customer arrives. In some embodiments, preserving the customer's place in the queue is performed by moving the customer back in the queue to a place that is expected to reach the front of the queue at a newly expected arrival time for the customer.

At block 510, if the customer is not approaching the retailer, the follow-through tracking engine 216 may move the customer back in the queue or remove the customer from the queue. Removing customers from the queue upon detecting a lack of progress toward the retailer may provide certain benefits to the retailer and to other customers who are also waiting in the queue by reducing clutter in the queue and by reducing a number of resources that the retailer may hold in reserve to be ready to service customers being tracked by the logistics management system 104. In some embodiments, a notification may be presented by the customer computing device 102 indicating that the customer is about to be removed from the queue if a proper notification reply is not provided, or if progress toward the retailer is not demonstrated.

Once the customer either arrives at the retailer and assumes the place in the queue, or is determined by the follow-through tracking engine 216 that the customer should be removed from the queue, the method 500 proceeds to an end block and terminates. One of ordinary skill in the art will recognize that the actions described with respect to blocks 506-510 may be performed repeatedly and/or continuously until the method 500 completes.

As will be understood by one of ordinary skill in the art, additional functionality may be provided by components described herein in order to further enhance the utility of the overall system. For example, in some embodiments, the predicted path information and purchase history information for a customer may be used to push advertisements for products to the customer computing device 102 for presentation along with the direction information. These advertisements may be for products that the customer has purchased in the past, products related to those products, or for any other product. The predicted path information may allow advertisements to be shown for products that could be obtained along the predicted path but for which product requests have not previously been created. As such, the advertisements may include an option to add a product request for the advertised product, and to thereby schedule a curbside pickup of the product. Since the predicted path is known and the product can be obtained without only a minimal commitment by the customer, such an advertisement may be particularly likely to be converted into an actual product sale.

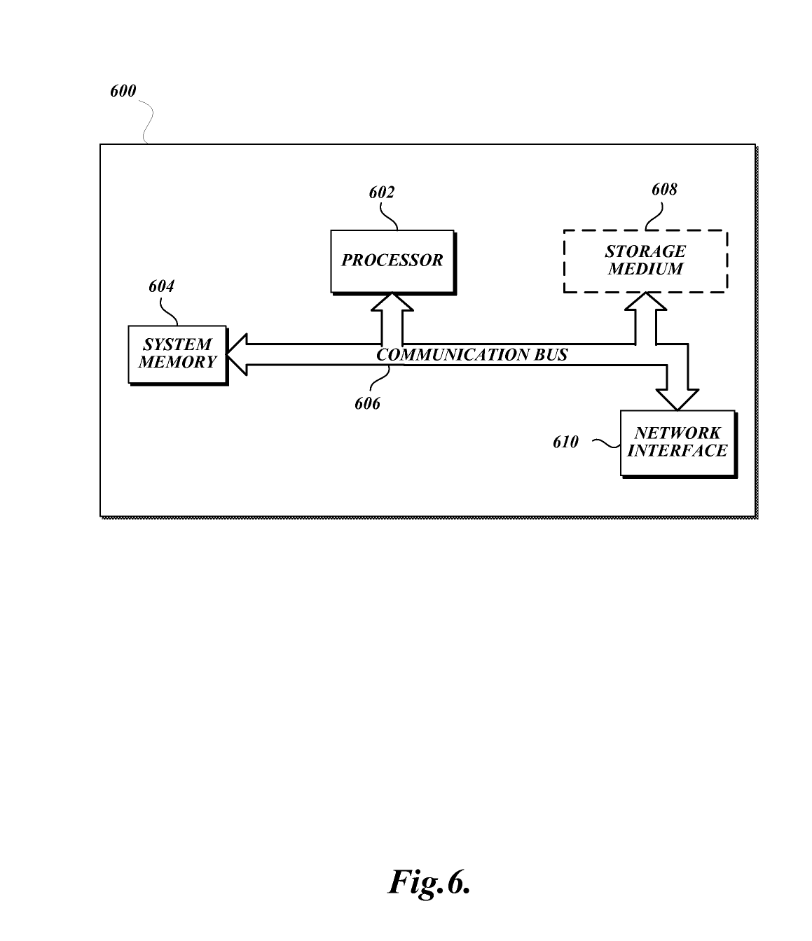

FIG. 6 is a block diagram that illustrates aspects of an exemplary computing device 600 appropriate for use with embodiments of the present disclosure. While FIG. 6 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 600 may be any one of any number of currently available or yet to be developed devices.

In its most basic configuration, the computing device 600 includes at least one processor 602 and a system memory 604 connected by a communication bus 606. Depending on the exact configuration and type of device, the system memory 604 may be volatile or nonvolatile memory, such as read only memory (“ROM”), random access memory (“RAM”), EEPROM, flash memory, or similar memory technology. Those of ordinary skill in the art and others will recognize that system memory 604 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 610 comprising one or more components for communicating with other devices over a network. Embodiments of the present disclosure may access basic services that utilize the network interface 610 to perform communications using common network protocols. The network interface 610 may also include a wireless network interface configured to communicate via one or more wireless communication protocols, such as WiFi, 2G, 3G, LTE, WiMAX, Bluetooth, and/or the like.

In the exemplary embodiment depicted in FIG. 6, the computing device 600 also includes a storage medium 608. However, services may be accessed using a computing device that does not include means for persisting data to a local storage medium. Therefore, the storage medium 608 depicted in FIG. 6 is represented with a dashed line to indicate that the storage medium 608 is optional. In any event, the storage medium 608 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer-readable medium” includes volatile and non-volatile and removable and non-removable media implemented in any method or technology capable of storing information, such as computer readable instructions, data structures, program modules, or other data. In this regard, the system memory 604 and storage medium 608 depicted in FIG. 6 are merely examples of computer-readable media.

Suitable implementations of computing devices that include a processor 602, system memory 604, communication bus 606, storage medium 608, and network interface 610 are known and commercially available. For ease of illustration and because it is not important for an understanding of the claimed subject matter, FIG. 6 does not show some of the typical components of many computing devices. In this regard, the computing device 600 may include input devices, such as a keyboard, keypad, mouse, microphone, touch input device, touch screen, tablet, and/or the like. Such input devices may be coupled to the computing device 600 by wired or wireless connections including RF, infrared, serial, parallel, Bluetooth, USB, or other suitable connections protocols using wireless or physical connections. Similarly, the computing device 600 may also include output devices such as a display, speakers, printer, etc. Since these devices are well known in the art, they are not illustrated or described further herein.

As will be appreciated by one skilled in the art, the specific routines described above in the flowcharts may represent one or more of any number of processing strategies such as event-driven, interrupt-driven, multi-tasking, multi-threading, and the like. As such, various acts or functions illustrated may be performed in the sequence illustrated, in parallel, or in some cases omitted. Likewise, the order of processing is not necessarily required to achieve the features and advantages, but is provided for ease of illustration and description. Although not explicitly illustrated, one or more of the illustrated acts or functions may be repeatedly performed depending on the particular strategy being used. Further, these FIGURES may graphically represent code to be programmed into a computer readable storage medium associated with a computing device.

While illustrative embodiments have been illustrated and described, it will be appreciated that various changes can be made therein without departing from the spirit and scope of the present disclosure.

The embodiments of the invention in which an exclusive property or privilege is claimed are defined as follows:

1. A computer-implemented method of managing curbside pickups of products from retailers, the method comprising:
calculating, by a customer path prediction engine of a logistics management system, a predicted path for a customer;
searching, by a retail negotiation engine of the logistics management system, retailer inventories associated with retailers near the predicted path for one or more products in a set of product requests associated with the customer;
creating, by a pickup management system associated with the logistics management system, one or more curbside pickup orders for products found within the retailer inventories of retailers near the predicted path; and
monitoring, by a follow-through tracking engine of the logistics management system, progress of the customer along the predicted path.

2. The computer-implemented method of claim 1, wherein the predicted path for the customer includes a set of predicted time points, wherein each predicted time point of the set of predicted time points includes a location and a time at which the customer is predicted to be present at the location, and wherein calculating the predicted path for the customer includes:
collecting appointment data for the customer from at least one calendar system, wherein the appointment data includes at least one appointment having an appointment time and an appointment location; and
adding the appointment time and the appointment location for each appointment to the predicted path.

3. The computer-implemented method of claim 1, further comprising:
collecting a set of product requests for the customer; and
storing the set of product requests in a customer data store.

4. The computer-implemented method of claim 3, wherein collecting the set of product requests for the customer includes monitoring inventories of products possessed by the customer.

5. The computer-implemented method of claim 4, wherein collecting the set of product requests for the customer further includes:
detecting that an inventory of a product has fallen below a predetermined threshold; and
creating a product request for the product.

6. The computer-implemented method of claim 1, wherein creating one or more curbside pickup orders includes, for a given product within the set of product requests that is offered for sale by a retailer near the predicted path:
determining whether the given product is offered for sale by an online marketplace system;
comparing whether the offer for sale of the given product by the online marketplace system is preferable to the offer for sale of the given product by the retailer; and
creating the curbside pickup order in response to determining that the offer for sale of the given product by the retailer is preferable to the offer for sale of the given product by the online marketplace system.

7. The computer-implemented method of claim 6, wherein comparing whether the offer for sale of the given product by the online marketplace system is preferable to the offer for sale of the given product by the retailer is based on one or more of a product sale price, a total order cost that includes shipping costs and tax costs, a predicted wait time for delivery, and an impact on a loyalty program.

8. The computer-implemented method of claim 6, further comprising:
transmitting a negotiation request to the retailer indicating a change to be made to the offer for sale of the given product in order to make the offer for sale of the given product by the retailer preferable to the offer for sale of the given product by the online marketplace system; and
creating the curbside pickup order in response to acceptance of the negotiation request by the retailer.

9. The computer-implemented method of claim 1, wherein monitoring progress of the customer along the predicted path includes:
detecting completion of a curbside pickup order for a given product;
finding a pending online order for the given product from an online marketplace system; and
canceling the pending online order in response to detecting the completion of the curbside pickup order for the given product.

10. The computer-implemented method of claim 1, wherein monitoring progress of the customer along the predicted path includes:
predicting that a scheduled curbside pickup order will not be completed by a predicted time for the scheduled curbside pickup based on a current location and direction of travel of the customer; and
rescheduling or canceling the scheduled curbside pickup order.

11. The computer-implemented method of claim 1, wherein monitoring progress of the customer along the predicted path includes:
predicting that a scheduled curbside pickup order will cause the customer to fail to arrive at a scheduled appointment at a scheduled time for the appointment; and
canceling the scheduled curbside pickup order.

12. A computer-implemented method of managing a position of a customer within a queue for a resource at a retailer, the method comprising:
adding, by a computing device, an entry associated with the customer to the queue for the resource at a retailer;
monitoring, by the computing device, a current location and a direction of travel of the customer; and
updating a position of the entry in the queue based on the current location and the direction of travel of the customer.

13. The computer-implemented method of claim 12, wherein updating the position of the entry in the queue includes:
determining that the entry has reached a front of the queue;
moving the entry to an appropriate position of the queue based on the current location and the direction of travel.

14. The computer-implemented method of claim 13, further comprising:
determining an expected time of arrival based on the current location and the direction of travel of the customer; and
calculating a new position in the queue, wherein the new position in the queue is expected to reach the front of the queue at the expected time of arrival;
wherein the appropriate position of the queue is the calculated new position in the queue.

15. The computer-implemented method of claim 13, wherein moving the entry to an appropriate position of the queue includes removing the entry from the queue in response to determining that the current location and the direction of travel of the customer indicate that the customer is not traveling to the retailer.

16. The computer-implemented method of claim 12, wherein the retailer is a restaurant.

17. The computer-implemented method of claim 12, wherein the retailer offers multiple resource types, wherein each resource type is associated with a separate queue, and wherein a queue for the customer is selected based on an attribute of a request by the customer to be added to a queue.

18. The computer-implemented method of claim 17, wherein the retailer is a restaurant, wherein the multiple resource types include tables of different sizes, and wherein the attribute of the request includes a party size.
